(19) United States
(12) Patent Application Publication
(10) Pub. No.: US 2007/0212545 A1
(43) Pub. Date: Sep. 13, 2007

(54) Differential Energy Composites and Method of Manufacturing Same

(76) Inventors: James W. Cree, Chesterfield, VA (US); Tomi Rae Millkon, Atlanta, GA (US)

Correspondence Address: TROUTMAN SANDERS, LLP, 5200 BANK OF AMERICA PLAZA, 600 PEACHTREE STREET, NE, ATLANTA, GA, 30308, US

(21) Appl. No.: 10/582,313

(22) PCT Filed: Dec. 8, 2004
(86) PCT No.: PCT/US04/41434

§ 371 Date: May 16, 2007

Related U.S. Application Data
(60) Provisional application No. 60/527,898, filed on Dec. 8, 2003.

(51) Int. Cl. B32B 33/00

(52) U.S. Cl. 428/409; 156/60

(57) ABSTRACT

Methods and articles are taught comprising differential energy composites. The composite is a unified structure comprising layers with differing surface energies. A differential between the surface energies exists and access may be provided through one layer to another layer, so that liquids may be drawn into the composite.

### CROSS-REFERENCE TO RELATED APPLICATIONS

This application claims the benefit of the filing date from U.S. Ser. No. 60/527,898, filed on Dec. 8, 2003, by James W. Cree, and Toni Rae Millikan, which disclosure is incorporated herein by reference.

### FIELD OF THE DISCLOSURE

The present disclosure is related to differential energy composites and their methods of manufacture. More particularly, the present disclosure is related to differential energy composites comprised of layered materials.

### BACKGROUND OF THE DISCLOSURE

Absorbent and other articles, (e.g., wraps, garments, packaging materials, etc.) are often comprised of layers of various materials. Certain attributes may be desired for the articles and their layers, for example, softness, wettability, breathability, elasticity, etc., yet it may be difficult to provide those attributes due to the sometimes opposing nature of the materials provided for the layers. For example, absorbency may desirably be provided by a certain type of material, e.g., a hydrophilic material, yet a comfortable layer next to the skin, one that doesn't feel wet, may desirably be provided by a different type of material, e.g., a hydrophobic material.

Various solutions to these difficulties, for example, providing a single material with different characteristics on either side, have been attempted. However, those solutions have been often less than desirable.

### BRIEF DESCRIPTION OF THE DRAWINGS

FIG. 1 shows a view of a preferred embodiment.

FIG. 2 shows a view of a preferred embodiment.

FIG. 3 shows a view of a preferred embodiment.

FIG. 4 shows a view of a preferred embodiment.

FIG. 5 shows a view of a preferred embodiment.

### DETAILED DESCRIPTION OF THE PREFERRED EMBODIMENTS

The present embodiments provide differential energy composites and their methods of manufacture. Articles of manufacture are also taught herein.

The details of one or more embodiments are set forth in the accompanying drawings and the description below. Other features, objects, and advantages will be apparent from the description and drawings, and from the claims.

Various preferred embodiments comprise at least two layers. Each selected layer either has, or is modified to possess, a desired surface energy. For example, certain preferred embodiments may have a first layer with a first surface energy, e.g., a hydrophobic surface energy, and a second layer with a second surface energy, e.g., a hydrophilic surface energy.

The nature of the desired surface energies of each layer are chosen so as to provide a surface energy differential in the formed composite. For example, one surface energy differential in the formed composite may be chosen in some embodiments when two layers are used, and one has a hydrophobic surface energy and another has a hydrophilic surface energy. As another example, another differential may be chosen in other embodiments when two layers are used, each with differing hydrophilic surface energies. As yet another example, another differential may be chosen in yet other embodiments when two layers are used, each with differing hydrophobic surface energies. In preferred embodiments, the energy differential is sufficient to at least partially drive fluid through the composite. For example, apertures are provided to a hydrophilic layer. Fluid will be driven at least partially through those apertures, and so through the composite by appropriate differential selection. Fluid may also be driven internally into a composite through the surface energy differential—that is, fluid placed atop the hyrophobic layer will be driven from the exterior of the composite into the interior of the composite, where it may then travel at least partially though apertures if provided and through the composite.

The layers are bonded together. In various preferred embodiments, one of the layers, the layer with lesser surface energy (called herein the “first” layer,) has, or is provided with, as is further described below, recesses. These recesses provide access to the layer with greater surface energy (called herein the “second” layer.) Greater surface energy (also referred to as greater energy and variants) is used herein as a term for a characteristic of a material that promotes quicker liquid movement as compared to a material with a lesser surface energy characteristic (also referred to as lesser energy and variants.)

These components; layers, differing surface energies, a differential between the surface energies and access through one layer that is bonded to another layer are components in preferred embodiments of the composite. Liquids may be drawn into the composite. A “composite” is defined herein as a material with at least two distinct, structurally complementary components combined, in a unified structure, to provide structural and/or functional properties that are not necessarily present in any individual component. For example, in various preferred embodiments, first and second layers are two distinct, structurally complementary components that are combined or bonded to provide a differential surface energy gradient that provides an ability to process liquids that contact the first layer—structural and/or functional properties that are not necessarily present in either individual component.

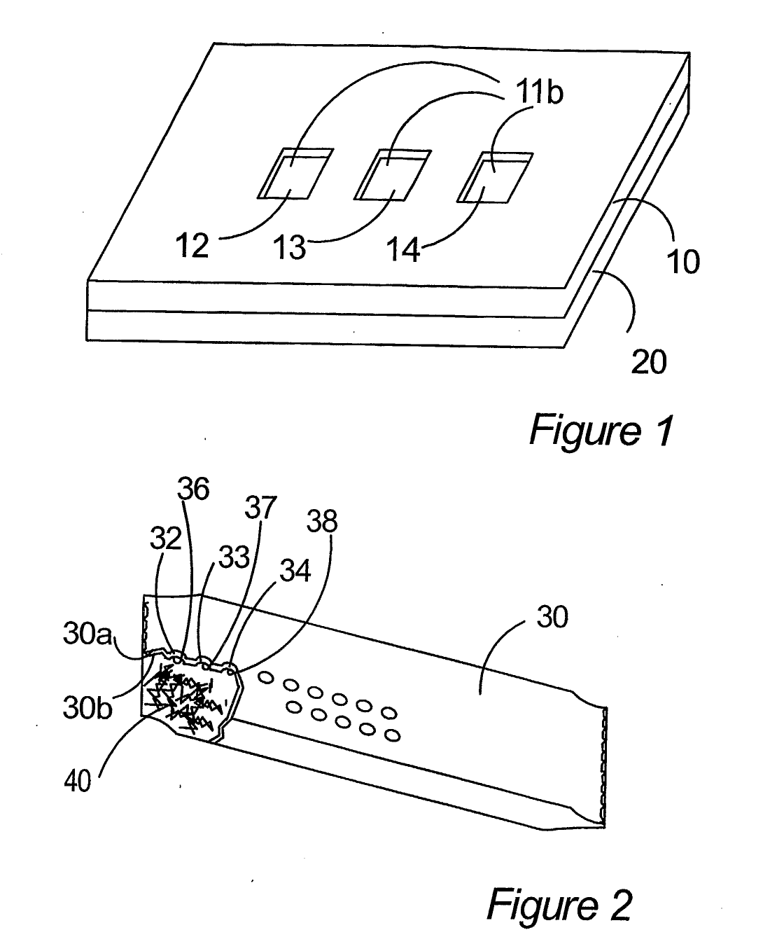

FIG. 1 shows a preferred embodiment. A first layer 10 and second layer 20 have been bonded together. First layer 10 is, in this embodiment, preferably a hydrophobic, nonwoven layer. Any suitable nonwoven layer may be used in this and other embodiments. An extensible nonwoven may be preferred in some instances. Of course, a nonextensible nonwoven may be preferred as well. Additionally, embodiments may combine extensible and nonextensible nonwovens if desired. Second layer 20 is, in this embodiment, preferably a hydrophilic film layer, however, any suitable material may be used in this and other embodiments.

At 12, 13 and 14 of FIG. 1, are shown areas of second layer 20 exposed through recesses in first layer 10. These are, in certain preferred embodiments, hydrophilic areas provided in a otherwise hydrophobic nonwoven layer 10. When a liquid is provided to the composite, the liquid will be repelled from layer 10 and attracted to the exposed portions of hydrophilic layer 20, at areas 12, 13 and 14.

Shown in FIG. 2 is a disposable article embodiment in the form of a sanitary napkin. Here a composite 30 is provided as a topsheet adjacent to an absorbent core 40. A backsheet, although typically present in such napkins, is not shown here. Recesses 32, 33, and 34 are shown in layer 30a of the composite, which is a hydrophobic nonwoven layer. Visible through recesses 32, 33, and 34 are areas of hydrophilic film layer 30b. In this embodiment, film layer 30b is apertured at 36, 37 and 38, providing pass-through for fluids, once the fluids have entered recesses 32, 33 and 34.

The topsheet of this and similar embodiments is usually of course in contact with the wearer's body. Any discharge from the wearer's body results in the discharge being repelled from layer 30a where a hydrophobic nonwoven layer is present. The discharge may then be drawn down by layer 30b, where at least part of hydrophilic film layer 30b is preset, because of the surface energy differential between the two layers, into recesses 36, 37 and 38. From there, the discharge may enter into absorbent core 40.

Thus, in the embodiment of FIG. 2 and other preferred embodiments, the energy differential between the composite's layers provides the potential for a liquid flow between the layers. The recesses in the first layer, providing access to the second layer, provide the composite with the structure to realize that potential. Thus, the composite provides a method within its unified structure to disperse a discharge internally.

In various embodiments, the differential between first and second layers may be controlled as desired. For example, it may be desired to have an extremely hydrophobic layer paired with an extremely hydrophilic layer so as to maximize the energy differential between the layers. (Of course, the hydrophobic layer has a low surface free energy—thus making it hydrophobic—and the hydrophilic layer has a high surface free energy.) Indeed, embodiments may provide for any energy differential between layers.

The first layer used in preferred embodiments is comprised of non-woven materials, including polyesters, polyolefins, acrylics, rayons, cottons and other cellulose materials, and blends of the same, etc. The form of a nonwoven layer may be any suitable type, such as, for example, spunbonded, thermobonded, meltblown, carded nonwovens, etc. and may comprise different basis weights, fiber compositions, fibers of different geometries, lengths, diameters and surface finishes. Preferred materials are provided by Shalag Shamir.

The second layer used in preferred embodiments is comprised of thermoplastic film material, such as polyethylene, polypropylene, nylon, ethylene vinyl acetate and other such polymeric materials.

Various treatments as known in the art may be used to provide hydrophilic or other surface energy characteristics to any layer. Additionally, if the material has a certain surface energy characteristic before, during, or after bonding, those characteristic may be changed at any time using various methods as known in the art. For example, layer surface energy may be increased, decreased, etc. through materials as known in the art, e.g., resin incorporated surfactants, corona treatment of the film, etc. These, and other treatments, may be used alone or in combination.

Embodiments may provide a composite using two or more different layers of materials. For example, a two layer composite may be provided as was described above, a three layer composite may be provided, a four layer composite may be provided, etc. Additionally, variable multilayer composites may be produced as well—for example, a composite having a two layer area, followed by a four layer area, followed by a three layer area, etc.

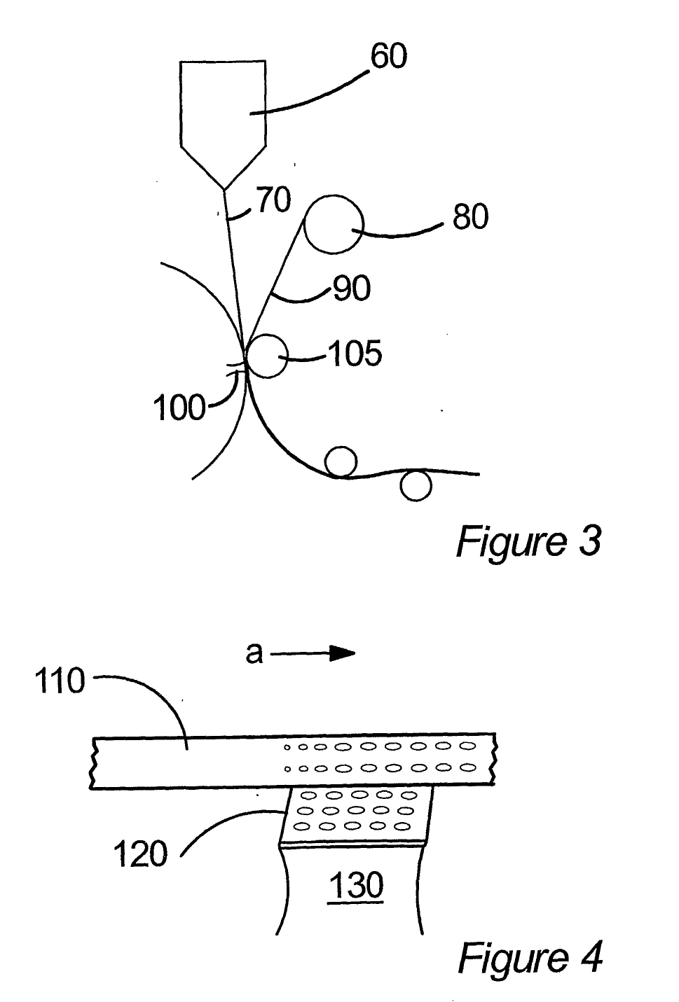

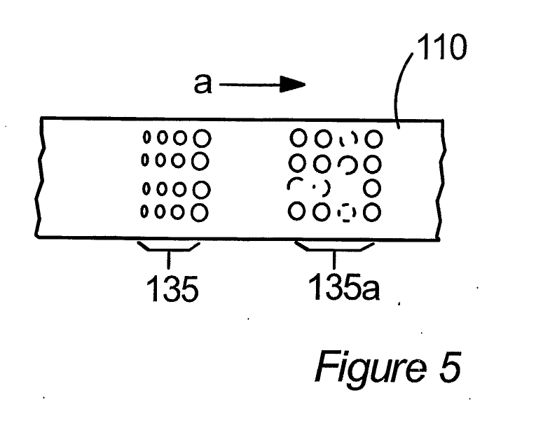

Turning now to FIG. 3, a view of a preferred embodiment is shown. Source 60 is for providing a resin material 70, which will comprise a hydrophilic layer. In this embodiment a source is shown that comprises an extrusion supply, however, any suitable hydrophilic layer source may be used in other embodiments including a precast polymer film layer.

Returning now to the embodiment of FIG. 3, source 80 is for providing a hydrophobic material 90. In this embodiment a source is shown that comprises a pre-formed roll of material, however, as was described above, any suitable hydrophobic material may be used.

In other embodiments, the hydrophobic material can be provided through extrusion, casting, carding machine, spun bond or meltblown equipment, etc.

FIG. 3 also shows pressure differential source 100. Pressure differential source 100 is for providing a pressure differential for providing apertures. Apertures may be provided to the hydrophilic layer and/or the composite. (In other embodiments, other means of aperturing, as known in the art, may be used.) In the preferred embodiments, apertures are provided to the hydrophilic layer, as is described further below. The apertures may be provided in order to allow pass-through of air or other fluids as desired, thus providing breathability and/or fluid permeability to the hydrophilic layer and/or composite.

Pressure differential source 100 may be any suitable source. In the preferred embodiments, pressure differential source 100 comprises a vacuum. An aperture definition device (not shown) may be used as well. In preferred embodiments, an aperture definition device is for providing direction to shape the apertures caused by pressure differential source 100, as will be described further below.

Pressure source 105 is for providing pressure to the materials, as will be further described below. A nip roll is used in the preferred embodiments, although any suitable source may be used as a pressure source. Additionally, some embodiments may dispense with a pressure source, or use a pressure differential source as a pressure source as well. Moreover, pressure source 105 is shown here as being present at a certain area; before the area where pressure differential source applies a pressure to the materials. However, it should be noted that a pressure source may also or alternatively be located at other areas, for example, where a pressure differential source applies a pressure differential; below the pressure differential area; etc.

Hydrophobic material 90 is brought into contact with hydrophilic material 70 and hydrophilic material 70 is, as well, provided to pressure differential source 100 which supplies a pressure differential that apertures the material. At the point of contact with pressure source 105, the materials may undergo bonding as well, as the pressure imposed by pressure source 105 assists in embedding hydrophilic material 70 and hydrophobic material 90 into their respective sides. The bonded materials comprise a composite.

Turning briefly to FIG. 4, a view of an aperture process of a preferred embodiment is seen. Hydrophilic material 110 passes over aperture definition device 120. In this and other preferred embodiments, aperture definition device 120 comprises a screen with 20 apertures per linear inch in a square pattern, referred to herein as 20 square. Other suitable aperture definition devices may be used in other embodiments. For example, aperture definition devices may provide various percentages of open areas, aperture sizes, geometries, etc. (For example, in various preferred embodiments, 25, 40 or other suitable mesh count may be used, and the topologies of the recesses may be a pentagram (“penta,”) ellipse, hex, etc.)

The preferred embodiments may also vary patterns while maintaining generally consistent fluid pass-through volume. For example, many smaller apertures may be desired, while fewer larger apertures may be desired in another area of the same material. The use of varying patterns may not affect pass-through volume: e.g., many smaller apertures in a surface area may equate to a similar pass-through volume as fewer larger apertures in the same surface area.

As the hydrophilic material passes over aperture definition device 120, in the direction shown as a, vacuum source 130 supplies a vacuum. The strength of the vacuum is sufficient to stretch areas of the material by pulling those areas into the apertures in aperture definition device, where the areas of the material in the apertures will eventually be stressed beyond their stretch limit and rupture. The ruptures will occur along the pattern supplied by aperture definition device 120.

It should be noted that in certain embodiments, it may be desired to impose a pressure differential on the hydrophobic layer only, prior to bonding. Thus, a pressure differential source may aperture the hydrophobic layer prior to bonding.

Returning to FIG. 3, bonding of hydrophilic material 70 and hydrophobic material 90 may occur in a number of ways. Some bonding may occur through contact with a molten or semimolten phase of either material, if it or they are provided as such. Bonding may also occur through imposition of pressure by pressure source 105. Bonding may occur through pressure imposed by pressure differential source 100. For example, in certain embodiments a vacuum will supply pressure to the materials and thus force them together, either in addition to a pressure source or instead of a pressure source.

Other methods of bonding may be used as well. For example, materials may be bound, in whole or part, using any suitable method, such as hot pin aperturing, adhesive bonding, thermal bonding, sonic bonding, or any other suitable method, and combinations thereof.

As was described above, the materials used in various embodiments may be any suitable type and form. Moreover, they may be modified as desired as well, e.g., thermally, chemically, mechanically, etc. As was described above the modifications may include modifying the surface energy characteristics of the materials.

In various preferred embodiments, providing access in the first layer to the second layer is through providing recesses in the first layer may be created in various ways. For example, activation stretching, of either the first layer, the second layer or, in preferred embodiments, the composite, may created the desired recesses. Activation stretching could occur through any suitable means, e.g., ring rolling, intermeshing gear activation stretching (“IMG”), etc.

Usually, activation stretching is directionally specific, so that, for example, stretching may be in the machine direction (MD), tentering direction (TD) (also known as the cross direction (CD)), diagonally, a combination of directions, etc. Other suitable methods may be used to create the recesses, for example, high pressure water jets, spikes, pins, etc. Other embodiments may use material that is pretreated to form the recesses before bonding, in addition to or instead of creating recesses.

Table 1 provides strikethrough and rewet data results using various base films for preferred embodiment composites as compared to a film layer only. Tests were similar to those set forth in EDANA standard 152.2-99. A manual timing method was used to clock various times.

Strikethrough Time was defined as the time (seconds) it takes for a given amount of testing fluid to be absorbed through a coverstock. Strikethrough time may be considered a measure of the efficiency of a topsheet in promptly allowing liquid to be absorbed by an absorbent core.

Rewet amount was defined as the amount (grams) of testing fluid that could be transported back out of the coverstock from inside the absorbent core. The amount of rewet may be considered a measure of the efficiency of the topsheet to resist the transport of liquid back onto the skin, which has already penetrated the coverstock.

25 Penta, Ellipse, and 40 Hex apertures were used in the examples as identified below. The hydrophobic layer was a nonwoven (16 gsm Thermal Bonded Carded.) Recesses were created through IMG. Saline was used as a test liquid.

TABLE 1

| | Strikethrough | | Rewet | |
|---|---|---|---|---|
| 25 Penta | 14.7 | sec. | 0.06 | g. |
| 25 Penta Composite | 5.0 | | 0.07 | |
| Ellipse | 63.8 | | 0.06 | |
| Ellipse Composite | 5.0 | | 0.06 | |
| 40 Hex | 34.9 | | 0.11 | |
| 40 Hex Composite | 5.7 | | 0.05 | |

Embodiments may provide increase perceived and/or actual softness over prior art materials as well. Table 2 shows the results of a softness comparison done by nine panelists on a panel softness scale of 1-10, with 1 being the softest possible feel. Three different sample composites were used: sample composites 1 and 1A were a 25 gsm air through bonded; sample composite 2 was a 22 gsm thermal bonded carded composite; and, sample composite 3 was a 36 gsm thermal bonded carded composite. Table 2 shows the results of the testing.

TABLE 2

| | | SAMPLE | | | | | | | |
|---|---|---|---|---|---|---|---|---|---|
| | | #1 | #1A | #2 | #4 | | | | |
| | | Com- | Com- | Com- | Com- | | | | |
| | | posite | posite | posite | posite | #1 | #1A | #2 | #3 |
| PANELIST | 1 | 3 | 5 | 2 | 1 | 4 | 7 | 6 | 8 |
| | 2 | 5 | 1 | 4 | 3 | 6 | 2 | 7 | 8 |
| | 3 | 4 | 3 | 2 | 1 | 6 | 8 | 7 | 5 |
| | 4 | 2 | 8 | 4 | 1 | 3 | 7 | 6 | 5 |
| | 5 | 2 | 3 | 4 | 1 | 6 | 5 | 8 | 7 |
| | 6 | 3 | 5 | 6 | 1 | 2 | 8 | 4 | 7 |
| | 7 | 3 | 1 | 5 | 4 | 6 | 2 | 8 | 7 |
| | 8 | 2 | 4 | 3 | 1 | 6 | 8 | 7 | 5 |
| | 9 | 1 | 4 | 2 | 3 | 6 | 5 | 7 | 8 |
| | Avg. | 2.8 | 3.8 | 3.6 | 9.8 | 5.0 | 5.8 | 6.7 | 6.7 |

Various embodiments may be used, in whole or part, in various types of articles, such as, for example, absorbent articles, including adult, child or infant incontinence products (diapers, briefs, etc.,) female menstrual products (e.g. sanitary napkins, pantiliners, etc.,) wraps, including sterile and nonsterile (e.g. bandages with and without absorbent sections,) as well as other disposable and/or multiple use products (e.g., articles proximate to a human or animal body, (e.g., garments, apparel, including under- and outer-wear, for example, undershirts, bras, briefs, panties, etc., bathing suits, coveralls, socks, head coverings and bands, hats, mitten and glove liners, medical clothing, etc.;) bed sheets; medical drapes; packaging materials; protective covers; household; office; medical or construction materials; wrapping materials; etc.)

A composite may also modified in any suitable fashion, for example, a composite may be sewn, bonded, printed, cut, shaped, glued, fluted, sterilized, etc.

Although the present invention has been described with respect to various specific embodiments, various modifications will be apparent from the present disclosure and are intended to be within the scope of the following claims.

1. A method of constructing a composite comprising, in any order:
selecting a first layer with a first surface energy;
selecting a second layer with a second surface energy greater than said first surface energy;
providing access in said first layer to said second layer;
bonding said first and second layers; so that said composite provides a unified structure wherein, the difference between said first surface energy and said second surface energy is sufficient such so that a liquid placed atop said first layer at least partially penetrates said access in said first layer to said second layer.

2. A method as in claim 1 further comprising providing access in said first layer to said second layer through activating said composite.

3. A method as in claim 1 wherein said first surface energy hydrophobic and said second surface energy is hydrophilic.

4-6. (canceled)

7. A method as in claim 1 wherein said first layer is a nonwoven layer and said second layer is a thermoplastic layer.

8-9. (canceled)

10. A method of constructing a composite comprising, in any order:
providing a first layer having a first surface energy;
providing a second layer having a second surface energy;
providing apertures in said second layer;
wherein said a second surface energy is greater than said first surface energy; and
wherein said composite provides a unified structure, wherein said unified structure has a differential surface energy gradient between said first and second layers.

11. A method as in claim 10 wherein said apertures are provided in said second layer using a pressure differential source.

12. A method as in claim 10 further comprising providing access in said first layer through activating said composite.

13. A method as in claim 10 wherein access is provided in said first layer to at least one of said apertures so that a liquid placed atop said first layer at least partially penetrates said access in said first layer to said second layer.

14. A method as in claim 13 wherein said second surface energy is sufficiently greater than said first surface energy to at least partially drive fluid through at least one of said apertures of said second layer and so through said composite.

15. (canceled)

16. A method as in claim 10 wherein said first surface energy is hydrophobic and said second surface energy is hydrophilic.

17. (canceled)

18. A method as in claim 10 wherein said first layer is a nonwoven layer, and said second layer is a thermoplastic layer.

19-20. (canceled)

21. A composite comprising a unified structure comprising:
a first layer with a first surface energy and having at least one recess;
a second layer with a second surface energy which is greater than said first surface energy;
wherein the difference between said first surface energy and said second surface energy is sufficient such that a liquid placed atop said first layer at least partially penetrates said recess in said first layer to said second layer.

22. A composite as in claim 21 where said second layer has at least one aperture; and
wherein the differential between said first surface energy and said second surface energy is sufficient to at least partially drive said liquid through at least one of said apertures of said second layer.

23. A composite as in claim 21 wherein said first layer is
a substantially hydrophobic nonwoven layers, and said second layer is a substantially hydrophilic film layer bonded with the nonwoven layer such that areas of the film layer are exposed through the nonwoven layer.

24-25. (canceled)

26. The composite of claim 23 wherein the formed film layer and the nonwoven layer form an activated composite.

27. A method as in claim 10, wherein the steps of providing said first layer, providing said second layer, and providing said apertures comprise:
introducing a first molten thermoplastic material to a vacuum forming drum;
exerting a vacuum on the vacuum forming drum to form said second layer with said apertures;
introducing fibers of a second thermoplastic material onto the film during, or soon after formation of the film, to create said first layer and thereby form a composite; and
activating the composite to create localized disturbances in the nonwoven portion of the composite such that the second layer is exposed through the second layer.

28. A method as in claim 27, wherein said fibers are molten.

29. (canceled)

30. A composite which can be prepared using the method of claim 10.

31. An absorbent article comprising said composite of claim 30, is an intermediate layer.

32. An absorbent article of claim 31 wherein said composite is an intermediate layer or a topsheet.

33. (canceled)

34. An absorbent article as in claim 31 selected from the group consisting of: a bandage, an infant incontinence product child incontinence product, an adult incontinence product, an incontinence product, a sanitary napkin, a female menstrual product.

35-40. (canceled)
